(19) United States
(12) Patent Application Publication
(10) Pub. No.: US 2005/0255842 A1
(43) Pub. Date: Nov. 17, 2005

(54) Communication system and method for comprehensive collection, aggregation and dissemination of geospatial information

(75) Inventors: Mark E. Dumas, Vienna, VA (US); James Stokes, McLean, VA (US)

Correspondence Address: WILLIAMS MULLEN, 8270 GREENSBORO DRIVE, SUITE 700, MCLEAN, VA, 22102, US

(73) Assignee: Spatial Data Analytics Corporation

(21) Appl. No.: 11/130,483

(22) Filed: May 17, 2005

Related U.S. Application Data
(60) Provisional application No. 60/571,771, filed on May 17, 2004.

(51) Int. Cl. H04Q 7/20; H04J 1/10; H04B 7/14; H04J 3/08

(52) U.S. Cl. 455/424; 370/315

(57) ABSTRACT

A communication system and method coordinates data collection resources, both in the field and remotely, in real-time so as to rapidly collect, organize and manage frequently changing geospatial information on a cellular level. The present invention further provides a system and method for ensuring the accuracy of data collection, including a rewards system which can reward formal and informal/ad hoc “field” agents for providing information pertaining to particular cells within an area of interest.

### REFERENCE TO RELATED APPLICATIONS

This application claims the benefit of U.S. provisional patent application Ser. No. 60/571,771, filed May 17, 2004 and entitled “System and Method for Organizing the Collection, Aggregation and Dissemination of Geospatial Information”, the disclosure of which is incorporated herein by reference.

### FIELD OF THE INVENTION

The present invention relates to spatial modeling, and more particularly provides a communications system and method for comprehensive collection, aggregation and dissemination of geospatial information for a variety of purposes.

### BACKGROUND OF THE INVENTION

Geospatial modeling offers an approach to solutions to a variety of corporate, governmental and individual problems. The effectiveness of a geospatial model is largely dependent upon the accuracy, detail and integrity of the data supporting the model. Past efforts at obtaining and organizing geospatial information have suffered from inefficient allocation of resources for data collection, improper coordination and evaluation of the collected information and duplicative, if not conflicting, data collection and reporting.

### SUMMARY OF THE INVENTION

One aspect of the present invention provides a communication system and method for coordinating data collection resources, both in the field and remotely, in real-time so as to rapidly collect and organize frequently changing geospatial information on a cellular level (i.e., discrete, small surface areas). Another aspect of the present invention further provides methods for ensuring the accuracy of data collection, including a rewards system which can reward formal and informal/ad hoc “field” agents for providing information pertaining to particular cells within an area of interest. Further aspects of the present invention will be apparent from the description, drawings and claims herein.

### BRIEF DESCRIPTION OF THE DRAWINGS

FIG. 1 is a block diagram illustrating the communication between a remote command team and a field team in accordance with one embodiment of the present invention.

FIG. 2 shows a schematic representation of a geographic area of interest (AOI) in accordance with one embodiment of the present invention.

FIG. 3 is a block diagram illustrating the communication between a single cell team and multiple field teams in accordance with one embodiment of the present invention.

FIGS. 4 and 5 are graphical illustrations of how an area of interest may be divided with areas of exemplary field team deployments highlighted in accordance with one embodiment of the present invention.

FIG. 6 shows an exemplary schematic of the coordination of multiple field teams and multiple cell teams in accordance with one embodiment of the present invention.

FIG. 7 shows an example display associated with an AOI in accordance with one embodiment of the present invention.

FIG. 8 is an illustrated flow diagram showing one method of spatial information collection and aggregation in accordance with one embodiment of the present invention.

FIG. 9 shows an example display associated with a system user which incorporates the movements of the system user in the AOI in accordance with one embodiment of the present invention.

FIG. 10 is a schematic diagram illustrating various devices which can be incorporated in the system and method of the present invention.

FIG. 11 is an example embodiment of a remote command component in accordance with one aspect of the present invention.

FIG. 12 is an example schematic of one embodiment of the present invention, showing an overall system incorporating external components in communication with the remote command component of the present invention.

### DETAILED DESCRIPTION OF THE PREFERRED EMBODIMENTS

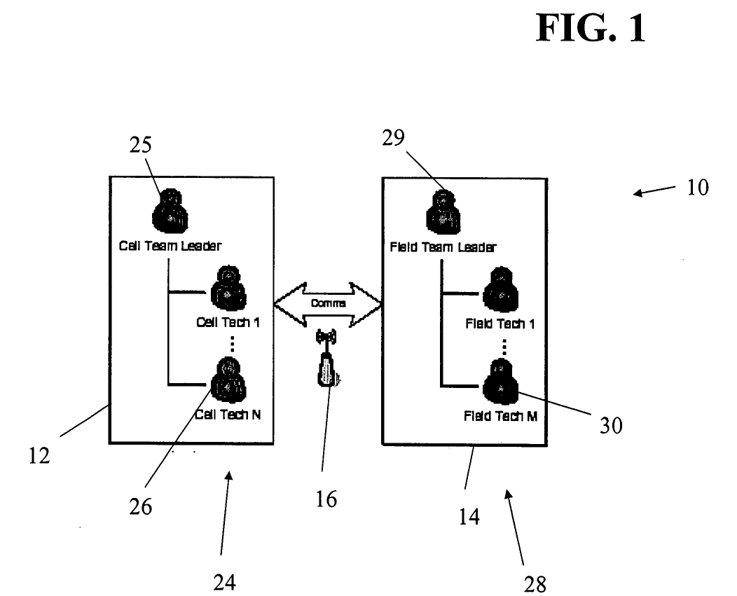

FIG. 1 is a schematic diagram showing the hierarchical arrangement and overall structure of one embodiment of the system 10 of the present invention. The system 10 as shown therein includes a remote command component 12, a field component 14, and a communications component 16 for providing two-way communication between the remote command component 12 and the field component 14. Communications component 16 can operate using known technologies to facilitate communication between cell-remote members and cell-local members, even in highly remote areas. Such communications can involve, for example, satellite uplinks from the cell-local member(s) sending signals to satellites for propagation and delivery to cell-remote members, cellular communications, wireline communications, and other known communication formats.

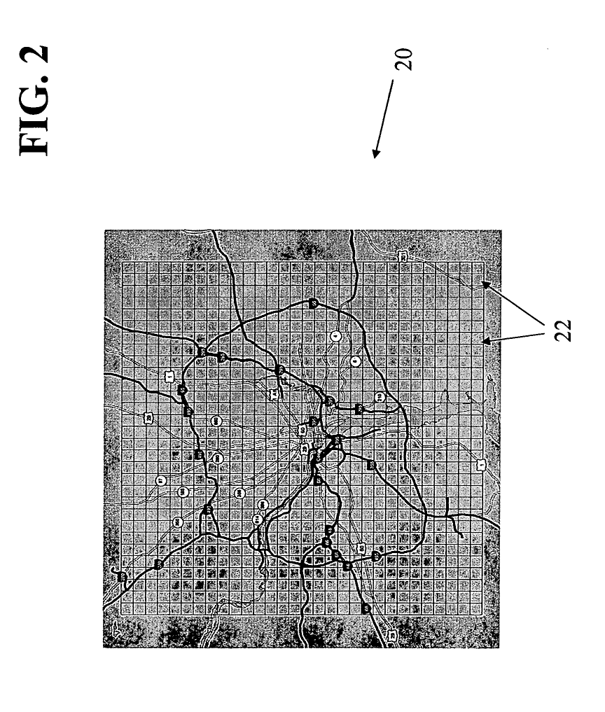

Remote command component 12 can be operated by a cell team 24, which can be a research, communications and/or business unit designed to efficiently collect and manage data as it operates in an area of interest (AOI). As shown in FIG. 2, an area of interest 20 (AOI) can be subdivided into smaller cells 22. An AOI 20 might be within a square perimeter of the Washington, D.C. area, for example. In one embodiment, the cells are generally uniform in size and are preferably in dimensions of multiples of one another. For example, a typical cell size might be 1 km×1 km. A cell team may remotely “visit” more than one cell in relatively rapid succession eventually visiting all the cells in the AOI. More than one cell team may operate in an AOI, working in a normal division of labor manner.

A cell team can be managed internally by a cell team leader 25, i.e. the manager of the cell team. Each cell team can further have one or more cell techs 26, or cell technicians, who are trained to use computerized software to assist in the collection and storage processes described herein. The cell team leader and the cell techs typically operate remotely away from the AOI, using a satellite-based or airborne picture to form a basis for collection. Each cell team may optionally be connected to one or more field teams 28 that operate directly in the AOI (i.e., the field teams are geographically situated in the AOI), in frequent communication with the cell team leader, to collect information while moving about. Each field team can be managed by a field team leader 29 and has one or more field techs 30, or field technicians, who are also trained to use computerized software to assist in the collection and storage processes described herein. For the purposes of the present disclosure, field teams and field agents can be said to be “cell-local” due to their local proximity within the cell and/or AOI, and cell teams and cell team agents can be said to be “cell-remote” due to their non-deployed, or remote, status.

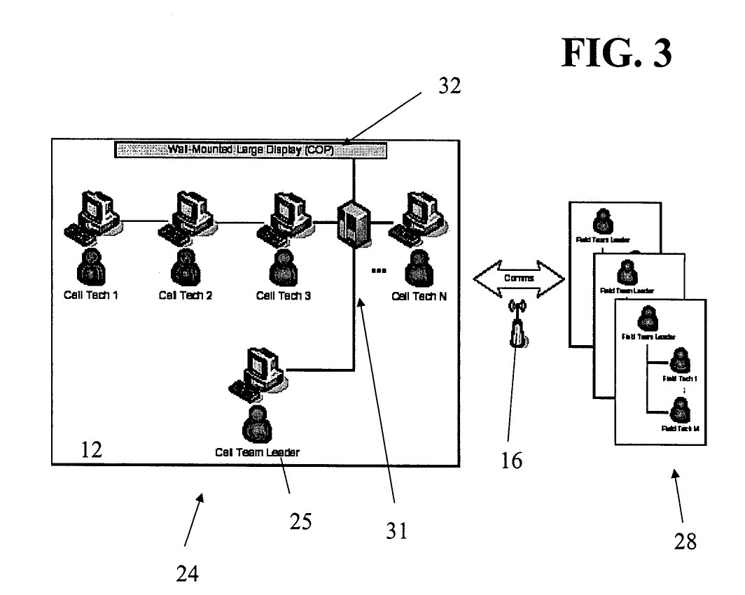

As shown in FIG. 3, each cell team 24 is internally networked as indicated at 31 and has a Common Operational Picture (COP) viewing component 32 that can display relevant, timely information for all the cell techs on the team to make sure efforts are not duplicated or to concentrate efforts where needed, for example. The cell team leader 25 can issue directives that propagate down through the cell team's COP 32. The cell team's COP 32 can display wide-area information useful in coordinating multiple cell teams as well as local area information between cell techs. It will be appreciated that the COP viewing component can comprise high end display technology capable of receiving a plurality of signal types for high resolution display thereon, including the accommodation of split screen options, as well as images received at various frame rates. Network 31 and computer systems provided for the cell team will be understood as comprising processors, memories, input and output devices, displays, and wireless and wireline networking connections communicating via common networking protocols as is known in the art.

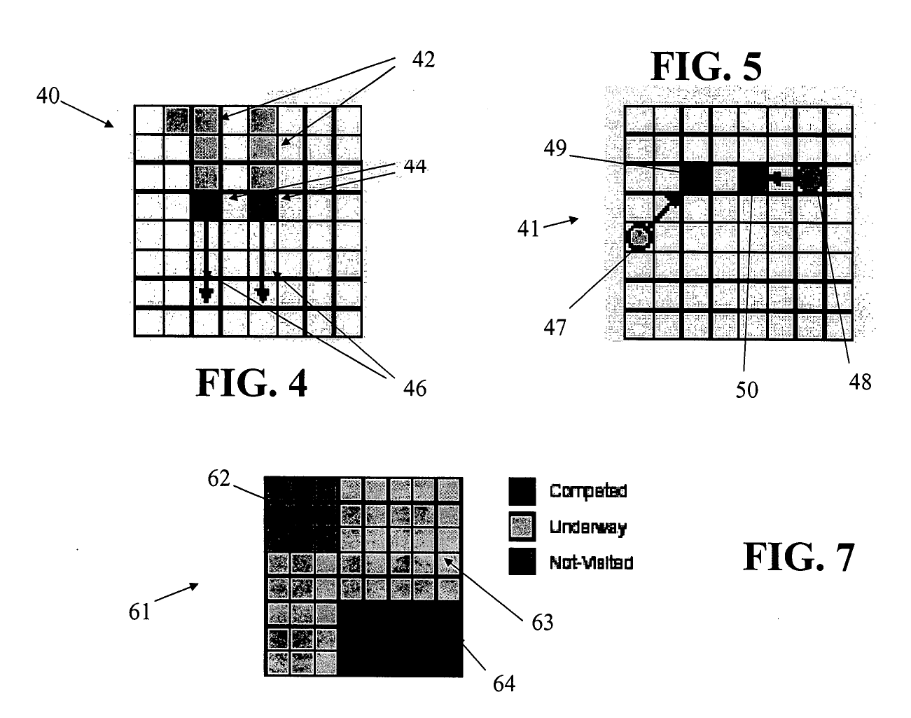

FIGS. 4 and 5 depict sample COP elements for cell team processing and coordination of field assets to support data collection. As shown in FIG. 4, for example, a COP display 40 can be highlighted to show where a field agent or cell-local team member has been as at 42, where the member is currently as at 44, and where the member is going as at 46. It will be appreciated that the cell-local member or team can be provided with one or more cell-local communicators in communication with the cell-remote team via communications component 16, so that cell-remote team 24 can direct the cell-local team's or member's efforts within the AOI. For example, cell-local member may be directed to continue in a respective one of the lines represented as 46 in FIG. 4, unless and until further notice is received. In another embodiment, as shown in FIG. 5, cell-local members 47, 48 can be directed to move to particular cells 49, 50, respectively within the AOI, and their positions can be noted as on the example display 41. Such directions are provided by cell-remote communicators based, in one embodiment, on information obtained and displayed on the COP 32. It will be appreciated that the cell-local communicator component operated by the cell-local member can be provided with a full or abbreviated version of the COP on a display to assist the cell-local member in understanding where to move within the AOI, as well as to assist the cell-local member in understanding what specific knowledge is desired for the targeted cell or cells. Also, it will be appreciated that references to a cell-remote or cell-local team can involve a single team member and references to a cell-remote or cell-local agent or member can involve a full team. Use of the term “member” or “agent” herein should not be interpreted as exclusively referring to a single individual unless specifically noted. Similarly, use of the term “team” herein should not be interpreted as exclusively referring to multiple individuals unless specifically noted.

Once the cell-local member(s) has reached the intended destination, collected the requested information and returned the information to the cell-remote team (e.g., at the remote command component), the COP can be updated to display results associated with the obtained information. Prior to display, the information can be vetted or evaluated to determine its quality and reliability based on one or several factors, including a known and/or stored reliability indicator for the particular cell-local member obtaining and sending the information.

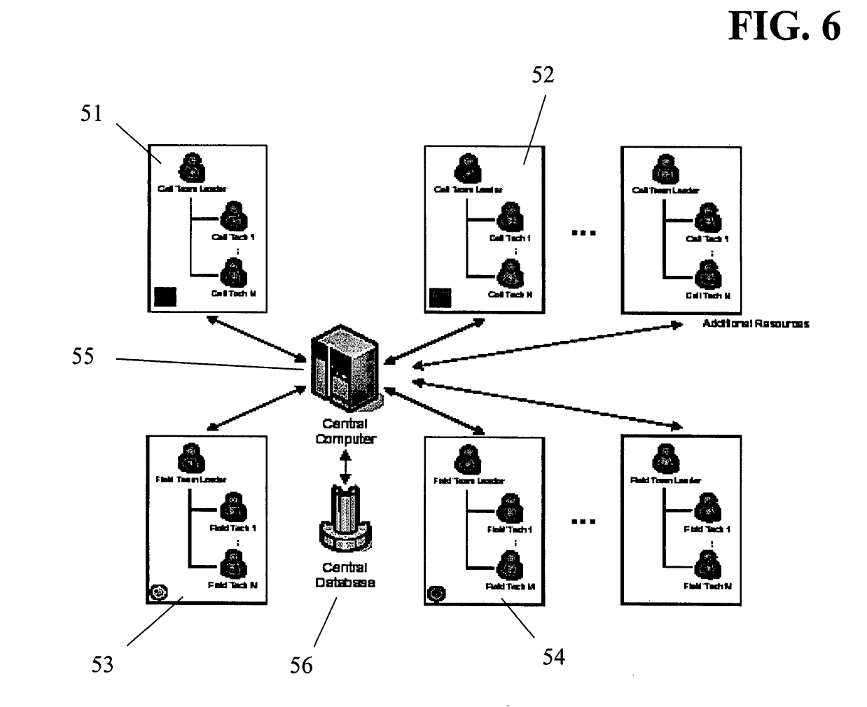

As shown in FIG. 6, in one embodiment of the present invention, all cell teams and field teams operate in a coordinated fashion managed by a central computer 55, which can be provided with human oversight. Thus, for example, cell team 51 can be initially paired with field team 53, cell team 52 can be initially paired with cell team 54, and so forth. In this embodiment, the central computer 55 can provide a Common Operational Picture (COP) to all elements in the AOI. The central computer further can connect to and manage a central database 56 for all data collection storage.

Cell teams can begin collection by rapidly digitizing their current collection cell using high-resolution airborne or satellite-based imagery. Typical collection themes can include, for example, water areas, building footprints, roads, traffic lights, sidewalks, monuments, parks, or anything else detectable from high-resolution imagery. Other assets can assist in defining themes such as elevation (radar) or soil cover (hyperspectral), for example. In one embodiment, cell teams can maintain a sufficient collection standard without any field teams, such as the case when collecting for areas in hostile foreign countries. Further, cell teams can ortho-rectify the imagery if it is not already ortho-rectified in preparation for digitization. Imagery used in the collection process can also be archived for change detection purposes as well as imagery reseller agreement purposes. In one embodiment of the invention, a change detection component is provided in connection with remote command component to provide a trigger to one or more cell-remote or cell-local agents to assess the change and/or take immediate action.

Field teams, or cell-local teams, can assist by provided GPS-based attribute information not readily apparent from imagery. An example would be the name of the monument or the type of building construction or purpose for a particular building. The coordinated COP (Common Operation Picture), made possible by the central computer, provides assistance because a cell tech can highlight a new building footprint in a cell to which a field team is assigned, for example. The new building, and the attributes previously identified for collection for that feature type (e.g., for a building footprint, the type of construction, purpose, and height, for example) become immediately highlighted in a queue to the closest field team in the vicinity for review and collection of the attributes. This field team can become immediately aware of the requirement due to the coordinated COP, and is in an ideal proximity to fulfill the data collection requirement.

As a specific example of the collection and evaluation processes in accordance with one embodiment of the invention, a cell-remote team may know through viewing images of an AOI that there are several buildings of unknown type which may harbor fugitives. Cell-remote team may also be aware through statistical and/or geospatial analysis pertaining to certain fugitive types that these fugitives are prone to assemble in abandoned warehouses. Because the building-types in the AOI are unfamiliar, the cell-remote team can dispatch one or more cell-local team members to one or more particular cells to gather on-the-ground intelligence about the buildings. Cell-local team members can receive the instructions on cell-local communicators, which can display thereon either directions to the desired cell, a map of the AOI or a portion thereof with targeted cell highlighted, or some other visual display instructing the cell-local member where to go, as described above. The communication from the cell-remote communicator can also indicate to the cell-local member the exact information required, such as, for example, whether the building appears commercial or residential, occupied or unoccupied, white-collar type or blue-collar type, and so forth. Upon reaching the intended destination cell or cells and acquiring the desired information, the cell-local member can use the cell-local communicator to send back the requested information.

The invention may then optionally employ a reliability test on the received information, which can be based on previously stored information about the cell-local member providing the information, or other factors which contribute to the reliability assessment. Such other factors can include, for example, how close the cell-local member was able to physically get to the targeted building, the weather, the surveillance time involved and other factors which may objectively increase or decrease reliability of such information. The previously stored information about the cell-remote member can include, for example, a rating based on previously submitted information by the cell-remote member which has been either subjectively evaluated or compared to ratings of other cell-remote members, and which may be developed through independent verification and validation (V&V) as described more completely elsewhere herein.

For the purposes of the present example, once the information received by the cell-remote communicator is deemed acceptably reliable, it can be presented on the COP either literally (e.g., if the building is a commercial white-collar building, the words “commercial white-collar” are printed on the COP (or an abbreviation therefore), or symbolically, as through color codes, information codes and other known methods. In one embodiment of the invention, if a threat or other signal is detected based on the received information, the COP can display “hot spots” or danger areas, which the cell-remote team can then use to communicate to other cell-local members to warn them of potential hazards. It will be appreciated that with multiple cell-local members providing information that can be assessed and updated to the COP in short periods of time, the COP display can become a rapidly changing, real-time display of activity and target zones within an AOI. The present invention, in providing the present system and display, can thus be used for crime analysis and prevention, military assessments and actions, targeted commercial activities and a wide variety of other uses.

The central computer 55 can perform automated scheduling for the cell-remote team's progression through the AOI. Furthermore, movements and data collection queues for the cell-local teams can be managed by the central computer. In one embodiment, all communications occur in real time and every asset “plays to the same sheet of music”. In this fashion, large grids of cells can be processed efficiently and thoroughly with significant cost and time savings. Cell-local teams can be said to be able to “ground truth” what cell-remote teams do remotely, as some features can be obscured by smoke, foliage, or clouds requiring cell-local teams to not just collect attributes, but location and perimeter information as well. Cell-remote teams can, in one embodiment of the present invention, digitize a large chunk of an AOI before cell-local teams are even sent to the area, which would give the central computer more flexibility in determining optimal routes and collection strategies for the cell-local teams. In one embodiment, cell-remote and cell-local teams can include military and/or part military/contractor personnel.

An advantage of the collection methodology of the present invention is that abstract man-made boundaries such as political boundaries are not barriers to the final output data in the AOI. The output data can be high resolution and complete for each and every cell in the entire AOI, regardless of whether political boundaries were crossed—such is the case for example in a tri-state area such as Washington, D.C. In one embodiment, the present invention can collect a 2D digital model of the cell as well as a 3D digital model.

For each cell in an AOI, a predetermined baseline collection set or target set can be identified (i.e., themes). The collection or target set can be image-based, text-based or a combination thereof, for example. In one embodiment, an image receiving component is provided as part of remote command component for receiving the image-based collection set. Water boundaries, wooded areas, building footprints, cliffs, urban features, monuments, roads, dams, bridges, military bases or vehicles, power lines, and power plants, are example themes which can comprise the collection set or target set. A predetermined set of attributes for each theme can be identified as well. For example, for bridges, bridge span in meters might be collected as well as bridge type. In one embodiment of the invention, when a cell-remote team identifies a new bridge in an AOI, as much attribute information as can be collected remotely from the high-resolution imagery is determined, such as bridge span, for example. However, the cell tech might not be able to determine the bridge type (e.g., suspension) from the imagery and would leave this attribute “null” or void. While constantly monitoring collection, the central computer, which also provides the COP, can keep track of uncollected attributes as well as uncollected areas so that cell-local teams (if available) may be dispatched at some point whether in real-time or at a later time to collect the additional information. Thus, the central computer can automate this dispatch with cell-local teams (connected in real-time) receiving the scheduling.

In another embodiment, the central computer can occasionally and purposefully allow a cell-remote team to revisit the recent completion of a cell by another cell-remote team for the purposes of independent verification and validation (V&V). This revisit could also entail other cell-local teams as well. The central computer can compare the results in an automated or human-assisted fashion in order to assign a grade or rating to the cell-remote team. Cell-remote team ratings are monitored and maintained for audit, motivational, and confidence-rating purposes.

In another embodiment, the central computer can occasionally and purposefully allow a cell-local team to revisit the recent completion of a cell by another cell-local team for the purposes of independent verification and validation (V&V). The central computer can compare the results in an automated or human-assisted fashion in order to assign a grade or rating to the cell-local team. Cell-local team ratings are monitored and maintained for audit, motivational, and confidence-rating purposes.

One result of the present invention is thus one or more high-resolution spatial databases that can be readily ordered as complete datasets for a cell or a set of cells, or a la carte if the requester only needs a certain theme from a cell or set of cells. The central computer provides an additional functionality by edge-matching completed adjacent cells to ensure features that span one or more multiple cells would properly “join” if visualized or analyzed digitally. Errors or warnings encountered during this process can be reviewed by a cell team as dispatched by the computer, for example.

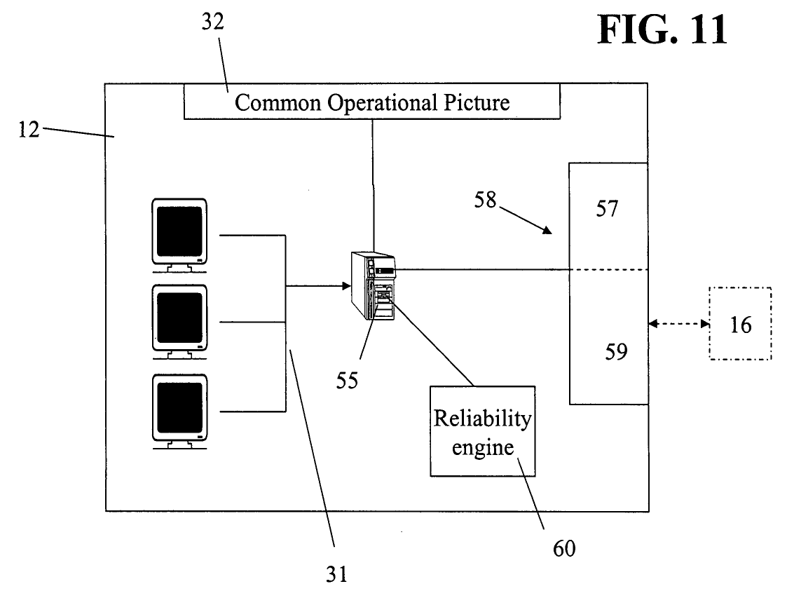

In one embodiment of the present invention, as shown in FIG. 11, the remote command component 12 comprises central computer 55, network 31, COP display component 32, communications component 58, which can have a collection set receiving sub-component 57 and a cell-local interface sub-component 59, and reliability determination engine 60. Central computer is in communication with each of network 31, display component 32, communications component 58 and reliability determination engine, as well as appropriate storage components (not shown) as will be understood to those of skill in the art. Collection set receiving sub-component 57 can have an image-based receiving element as well as a text-based receiving element. Cell-local interface 59 is in two-way communication with communications component 16. Reliability determination engine 60 can incorporate programming to store, update and assess reliability indicators for particular individuals, cell-local teams, and cell-remote teams, and can further incorporate programming to assess the sufficiency and reliability of an AOI as depicted in the COP, for example. If, for example, the preliminary collection set obtained for a given AOI is determined to be of insufficient quality, the reliability engine can detect this, and notify the central computer accordingly. The central computer can present this information to network users, can illustrate the deficiency on the COP, and can assist in deploying and/or notifying one or more cell-local teams or members to assist in collecting information to fill the quality deficiency. It will be appreciated that central computer can be adapted to automate the evaluation and deployment functions, or can be adapted such that a notified team member (e.g., cell team leader) reviews the information and assesses whether the situation is one which necessitates a field deployment. In one embodiment, programming can be provided to prioritize AOI's and individual cells for field work.

The central computer can employ programming for associating information received from the collection set receiving component (whether image or text-based) with one or more cells within a given AOI, and for determining whether the collection set meets an established quality criteria (such as through reliability engine 60, for example). The central computer 55 can further employ programming for communicating a signal to a cell-remote communicator if the quality criteria is not met, and for receiving a signal from one or more cell-remote communicators to notify a cell-local communicator of the cell or cells which require further information in order to meet the quality criteria. In one embodiment of the invention, a cell-local communicator receiving a notification or deployment directive can assess an individual situation and can re-assign a deployment directive to another cell-local member. For example, the system of the present invention may be adapted to notify the nearest cell-local communicator to the cell or cells targeted for field analysis, or the system may be employed such that the notification is sent to the cell-local communicator in use by a cell-local member of a certain reliability threshold. In some instances, the recipient cell-local communicator may also be otherwise occupied such that another cell-local member would be better suited to move to the targeted cell or cells for collection. In such case, the initial recipient can notify both the second cell-local communicator as well as the cell-remote communicator of the change in cell-local communicator targeted for collection. It will also be appreciated that the central computer can be distributed for redundancy or efficiency according to standard industry practice.

In one embodiment of the invention, a cell-remote communication can be directed to a general audience of cell-local communicators, and collection tasks assigned according to responses received from the cell-local communicators. In this embodiment, the communications component 58 can include programming for determining the location to which the general message is sent. This location can be determined based on GPS technology associated with a device being carried by the user, for example. Alternatively, this location can be determined by registered information collected about the users, such as residential zip codes, telephone area codes and/or other information that can be used to attempt to reach users in a particular geographic location.

As shown in FIG. 10, cell-local communicators 65 can comprise not only GPS receivers and communications equipment, but PC tablets, handheld PCs, cell phones, digital cameras, laptop computers, laser rangefinders, binoculars, and anything else that might assist in the collection process. In one embodiment, field techs can see the world digitally through goggles or any other heads-up-device known in the art that can project digital data on the real world. In this way, features needing collection (or already collected) could be highlighted in the field tech's vision. This can effectively comprise an extension of the COP except that, instead of looking at flat screens, for example, the field tech looks at the real world with a digital “lens” so to speak.

Cell-local teams might move via land, sea, or air, such as walking, biking, riding in a car, riding in a helicopter, riding in an airplane, riding on a motorcycle, or riding in a boat or submersible. Cell-remote team leaders might have the authority to dispatch Unmanned Aerial Vehicles (UAVs) and other robotic collection assets to get a closer look at a feature. In this way, a cell tech might control such a piece of equipment to obtain a view as if he or she were in the field.

As shown in FIG. 7, one type of COP display can be a progress assessment or data availability readiness display 61. Areas on the display can change to a different state in real-time as the status of a cell changes. For example, a portion of the display 61 shows completed cells having up-to-date information as at 62, a portion of the display currently being updated as at 63, and a portion of the display where further information is required or where cells have not yet been visited as at 64. Cells can be also be flagged by team members for periodic review and re-evaluation (e.g., rivers change course, buildings are built, land is cleared, tanks are moved). Cells flagged for re-evaluation and collection could first be assessed by the central computer by comparing the most recent airborne or satellite-based imagery to the most recent imagery on file used in the most recent revision of the cell's dataset. Automated and semi-automated change detection methods and associated programming can be provided in accordance with the present invention to determine where two images might differ, resulting in a highlight to an area where sufficient change is detected. In one embodiment of the present invention, change detection programming is provided as part of central computer 55.

One advantage of a particular embodiment of the system of the present invention is that, when the system detects a change, the central computer can decide on the best course of action. The system, for example, can wait until a sufficient score is met, reflecting a progression of change events to dispatch a cell team to revisit the cell. In other words, a change status or rating can be maintained for each cell that reflects the “up-to-date” status of the cell. This status can be expressed as a percentage of 1 to 100%, for example. When the percentage passes a threshold, the dispatch from the central computer is issued. Further, the system can determine that a detected change is sufficient to be incorporated into the COP, for example. In one embodiment of the present invention, this determination is conducted using programming in connection with central computer 55, such as might be provided, for example, by reliability engine 60. If newly acquired information is deemed acceptable, the present invention can store it and update the baseline data set, such that further change detection analysis incorporates the most current, accepted information. The present invention can further update cell-local communicators with the updated baseline data set, such as depicted on the updated COP.

In addition, features themselves can be provided with a confidence attribute. If change detections occur near or at previously defined features, those confidences or ratings can be decreased automatically. Further, certain cells in an AOI can be entirely skipped through a “mask” of cells to avoid. These might be masked because they are cells entirely within the border of a lake or ocean area, or perhaps a designated military or sensitive security facility (e.g., nuclear power plant). Further, each cell can be provided with a unique identifier for reference purposes, which, in one embodiment, is unique across the whole globe. Metropolitan areas such as Washington, D.C. can, for example, represent the seamless merge of a number of cells associated with the Washington, D.C. area. In other words, Washington, D.C. might be known to be cells 232, 233, 234 . . . 246, for example. Separate processes can access the collection database repository to merge those cells together in bundles for sale or delivery, in one embodiment of the invention. For example, cell data and combined cell data can be made for sale over the Internet, for immediate download, by CD, DVD, or other known media delivery means. In one embodiment, the present invention is provided with a brokering component in communication with computer 55 for combining cell data, establishing connection and conducting transactions therefore.

In one embodiment of the present invention, the central computer can operate programming so as to register cell-remote teams and members, cell-local teams and members, areas of interest and cells within areas of interest. Programming can also be provided in connection with central computer to associate one or more groups of cells, monitor cell and cell feature status, and locate teams or members.

User registration can be provided through a registration component in communication with the central computer and comprising part of remote command component 12. Further, recognizing that in conventional data collection processes, salaried employees, consultants, or business partners are used to collect information, the present invention can further enable ad hoc or informal contributions from the “man on the street”. In one embodiment, ad hoc agents can be rewarded for contributions to the data collection efforts involved in the present invention through a rewards component described more completely hereafter. Further, the present invention can extend its application to the corporate or military environment in a similar methodology as dealing with the public. In other words, the field teams, or cell-local teams, can comprise members of the general public, where each participating member of the general public becomes his or her own individual field team.

Communications with the general public can occur over existing and developing wireless networks to transmit data collection requests. A request might be, “what type of building is the building located at 1344 Carpers Farm Way?”. The answer might be structured such that there are only a limited number of valid responses, such as “domestic housing”, “commercial”, “brick”, or “wooden”, for example. These communications can be provided on displays of individuals PDAs, Cell Phones, Pocket PCs, or other portable electronic devices. The data request can include, for example, a request to capture a coordinate, request attribute information, or a picture or video.

A request might entail, for example, a satellite image be transmitted to the individual indicating and highlighting the item of interest. This can be done, for example, by highlighting the boundary or footprint of a building on an airborne or satellite image to help the individual recognize which building to focus on. This transmission can even include the individual's location and a path to get to the requested feature. Because the participation of public individuals is voluntary, a novel and key component of the present invention system is that individuals are enticed to participate because of a rewards program, where an individual can receive incentives to report data. Possible incentives can include, for example, money, stock, paid-for (either partially or fully) credit towards a mobile electronic device (such as they one they use to communicate) or other consumer product, or emotional and psychological incentives like loyalty and patriotism. Individuals can register to participate with the program via a registration component comprising a web site or other known element, for example. Using the registration component, the individual's communications profile can be recorded, e.g., how they can be contacted, including phone number, the make and model of the device, etc. In one embodiment, the user can optionally select to remain anonymous. Further, users can elect to allow their position to be monitored such that timely requests can be made to them based upon their location (i.e., “find out what religion the church 40 meters to the east of your position is”). These users can be referred to as “registered users” or “validated users”. All registered users can be assigned a unique ID number for tracking purposes in the internal system.

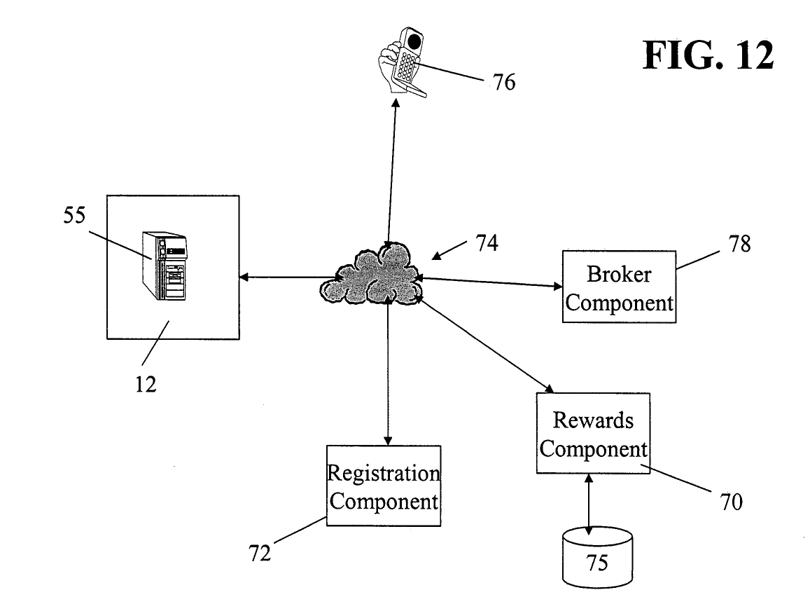

The rewards component can be provided in communication with computer 55, and can track registered users, update their performance and ratings, and assess performance against reward metrics to provide rewards such as might be stored in a rewards database, for example. In one embodiment, as shown in FIG. 12, rewards component 70, registration component 72 and broker component 78 are provided in communication with remote command component 12 and central computer 55 via a network 74 such as the Internet, for example. Rewards component 70 stores rewards information in, and accesses and retrieves information from, rewards database 75. In this embodiment, users 76 can access the registration component 70, rewards component 74 and broker component 78 apart from accessing the remote command component 12. Users 76 can be registered and ad hoc users communicating with registration component 72, potential purchasers of brokered data communicating with broker component 78, as well as third party rewards providers communicating with rewards component 70. It will be appreciated that broker component 78 can be provided with appropriate software and hardware safeguards to ensure security of data as well as transaction security during any electronic transactions or electronic transfers of data as might occur.

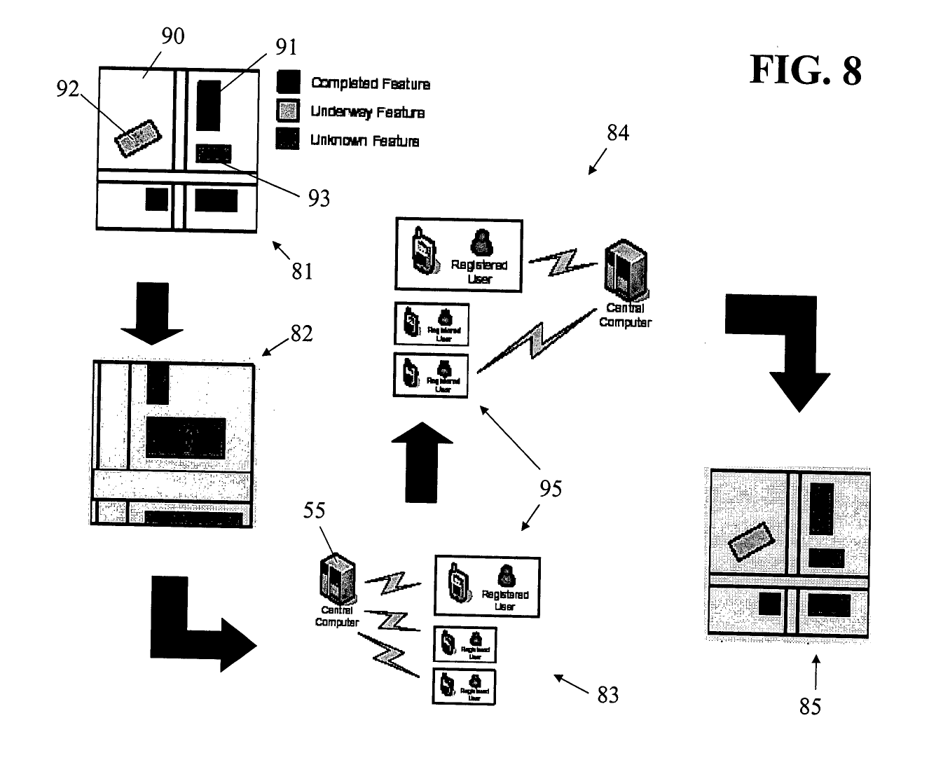

FIG. 8 demonstrates the steps involved in a particular embodiment of the present invention, whereby an unknown feature in a given cell is updated by a registered user. As shown in step 81 in FIG. 8, a particular cell 90 is analyzed to determine elements for which feature information is completed 91, elements for which feature information is in progress 92, and elements for which feature information is unknown 93. Upon determining an element for which feature information is unknown 93, as in step 82, the central computer 55 can notify registered users 95 of the element, as in step 83. It will be appreciated that in conducting step 83, the present invention can assess locations of registered users (to the extent the users allow the invention to track their whereabouts such as through GPS systems incorporated in user devices), and can further assess user reliability and proximity to the feature or element at issue. As at step 84, one or more users 95 respond to the central computer, which then updates the information for the element as in step 85. The element is then shown as having completed feature information.

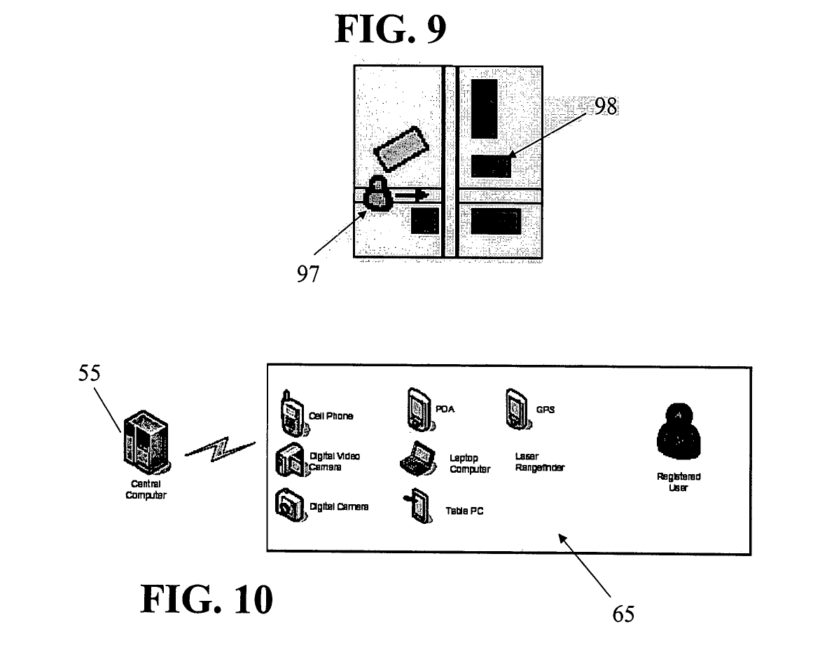

The method of the present invention in FIG. 8 can be made more robust by those users willing to allow their position to be monitored. For those individuals, indicated at 97 in FIG. 9, more robust decisions can be made by the central computer to send requests to them based upon their current location and proximity to a feature of interest 98. These users will benefit by more than likely increased volume of requests from the system, thereby offering the opportunity for more rewards.

It will be appreciated that users can be contacted through a variety of means. Requests could occur not only through the cell phone medium, but might include or be coupled with PDAs, video cameras, digital cameras, laptops, etc. (see 65 in FIG. 10). Requests can be brokered over existing wireless Internet infrastructure, for example, and user devices can be adapted to receive electronic messages and notifications as is known in the art.

Users can also fulfill requests offline. For example, an email or message can be sent to the user and the user can drive by the location on the way home from work taking note of the requested information. When the user arrives home, the information can be entered via the website for the request, if the request was still open for input by the central computer. In one embodiment, the rewards program is handled by an externally operated computer system (see reward component 70 in FIG. 12, for example), which can assist in providing anonymous users with rewards, for example. In this case, the external system would handle the payout and would know the address and taxpayer information for each anonymous ID in the system. In one embodiment, messages are merely sent, whether in real-time or periodically (rollups) crediting an ID and the amount.

Verification & Validation (V&V) can be handled by the system allowing more than one user to report on a request. If two users report and the responses do not match up (in the case of “form” type responses), then the system can, in one embodiment, dispatch another request to get a third opinion. If a majority of users respond with the same information and a minority disagree, then depending upon the information sought, the present invention can deduct “credibility” points from the minority users. In other words, their rating might go down. In one embodiment of the present invention, users that report without incident, particularly time after time, can see their credibility rating climb higher. Historical V&V might occur after the fact (e.g., a 2 month review) for a feature to either a) update the feature attributes or metadata (such as a video clip) or b) review after the fact another user's submitted information. Reporting and rating data can be collected, stored and assessed by reliability engine, in one embodiment.

Previously attributed and known features can be provided such that they come up for review in the system and are sent to users (as in the previous manner) when the central computer detects a change in the system, such as change detection through imagery analysis. This would prompt a re-collection for a particular feature. In such a case, the system can take advantage of historical records to submit a request back to a user or set of users who had previously reported on the feature.

In one embodiment, integration with “ad-hoc” technology can allow for easier communications than via the wireless Internet framework, depending on conditions. A mobile “ad-hoc” network is a collection of mobile devices equipped with a transmitter and receiver, connected in the absence of fixed infrastructure. As opposed to fixed wireless networks, mobile ad-hoc networks have no master slave relationship. Nodes in an ad-hoc network rely on each other to established communication; thus, each node acts as a router. As such, a packet can travel from a source to a destination either directly, or through some set of intermediate packet forwarding nodes in a mobile ad-hoc network. Ad-hoc technology can allow for messages to be transferred from the collection system to users by hopping or “piggy-backing” other users.

Other technologies can be integrated into the communications chain such as Bluetooth, wide area wireless, or even satellite-based services (e.g. satellite cell-phone providers, satellite digital relays, or XM radio). In one embodiment of the present invention, the U.S. Department of Defense or U.S. military can benefit from the present invention. For example, certain soldiers in the U.S. “Echelon” system can be designated as equivalent to registered and/or validated users. These soldiers, dubbed “Spatial Forces”, can thereby fulfill dispatched data collection requests in the field. Organizations such as Department of Homeland Security (DHS) could also benefit by the general public's reporting of features via the system.

In one embodiment of the invention, communication and management is not limited to merely features, but rather “events” of interest can be included. For example, car accidents, attacks (combat), observations, etc. can be recorded and evaluated. Events are treated no differently than features in the data collection system except that they are more dynamic in nature, resulting in the fact that the central computer and system would likely not request information about a particular event, but rather would transmit that it would be interested in receiving information about those types of events. It would be up to the user to transmit the requested data when those events occurred (e.g., such as a GPS location, time and date, and whatever attributes were requested). Further, it will be appreciated that the present invention can accommodate incorporation of cultural or social-type feature sets, in addition to physical “structure” type feature sets. For example, a structure may be recognized as a religious structure, but a social feature of the structure can be the type of religion associated with the structure (e.g., Muslim, Christian, Jewish). Some such features can necessarily involve a more subjective determination (e.g., is a neighborhood a “safe” neighborhood? Is a street a “busy” street during certain times of the day?). The present invention can further address reliability of input on such cultural and subjective feature sets in a manner similar to that for structural elements and feature sets.

Voice-activated systems such as handhelds, cell phones, and car electronics can also be incorporated with the present invention, as such systems drastically aid in reporting features and events back to the central system, allowing the user to continue in whatever their activity might be while reporting (e.g., driving, firing in combat, biking, etc. . . . ). Other system requests can include, for example, census estimates or census reporting, weather information requests, or anything of nature in which spatial location is an attribute or factor.

In one embodiment, users can be outfitted with special goggles to allow them to see the world digitally, basically share the Common Operational Picture described above, to see what data needed to be collected or had been collected. In a specific embodiment, some users or military personnel can be provided with laser “guns” or rangefinders to allow them to “paint” a semi-distant feature such as a mosque and report it back to the central system. The central system takes into account the rangefinder and embedded GPS technology to automatically send the corrected location and height of the structure from a distance, in addition to whatever attribute or other reported information might be sent.

Military personnel can maintain a credibility rating as well, although the system could be configured to allow for fewer soldiers to agree on an event or feature characteristics before certifying the addition. Reporting software can include special lightweight applications on mobile phones or computers, such as easy-to-use form-based reporting frameworks. (e.g., Microsoft CE™ or Java™). The rewards component can reward registered users for training subordinate users and compound rewards for those users getting others involved, for example.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed and desired to be secured by Letters Patent is:

1. A computer-based communication system for managing the collection, aggregation and dissemination of geospatial information, comprising:
a remote command component for use by at least one cell-remote communicator;
a field component for use by at least one cell-local communicator;
a communications component for providing two-way communications between said remote command component and said field component;
a common operational picture (COP) viewing component defining at least one area of interest (AOI) and at least one cell within said AOI;
an image receiving component in communication with said remote command component;
programming associated with said remote command component for associating information from said image receiving component with said at least one cell, and for determining whether said information meets a pre-determined quality criteria; and
programming associated with said remote command component for communicating a first signal to said at least one cell-remote communicator if said criteria is not met, and for receiving a signal from said at least one cell-remote communicator to notify said at least one cell-local communicator of the identity of said at least one cell.

2. The system of claim 1 further including means associated with said remote command component for determining and signaling to either the cell-remote communicator or the cell-local communicator specific cells which are in need of additional information.

3. The system of claim 1 further including means associated with said remote command component for determining a prioritization for focusing the attention of said cell-remote communicator and/or said cell-local communicator on specific cells for which further information is needed.

4. The system of claim 1 further including means associated with said communications component for determining a location to which a general message can be sent, such that said message is received by said at least one cell-local communicator in the given location and displayed on a display associated therewith.

5. The system of claim 4 wherein said location can encompass one or more cells within one or more AOI's.

6. The system of claim 1 further including means associated with said remote command component for establishing registered cell-local users and ad hoc cell-local users.

7. A computer-assisted method for managing the collection, aggregation and dissemination of geospatial information, comprising the steps of:
defining an area of interest (AOI);
defining at least one cell within said AOI;
providing two-way communication between at least one cell-remote communicator and at least one cell-local communicator;
gathering, by said at least one cell-remote communicator, primary information pertaining to said at least one cell;
determining, by said at least one cell-remote communicator, whether said primary information meets a pre-determined quality criteria;
upon said gathered information not meeting said criteria, receiving a signal from said at least one cell-remote communicator to notify said at least one cell-local communicator of the identity of said at least one cell;
receiving, from said at least one cell-local communicator, supplemental information pertaining to said at least one cell until said primary and supplemental information meet said criteria.

8. The method of claim 7 including the step of establishing a scoring system as part of determining whether information gathered meets said predetermined criteria.

9. The method of claim 7 including the step of providing a common operational picture (COP) for viewing by said at least one cell-remote communicator on a display associated therewith.

10. The method of claim 7 including the step of establishing a common operational picture (COP) for viewing by said at least one cell-local communicator on a display associated therewith.

11. A computer-assisted reward system comprising:
a data collection component having a cell-remote team input component and a cell-local team input component;
a registration component for accepting and processing registration information to establish registered field users;
an evaluation component for evaluating information provided to said collection component from said registered users via said cell-local team input component;
a rewards component for compensating said registered users based on the evaluation by said evaluation component.

12. A computer-assisted geospatial analysis engine, comprising:
a data collection component having a cell-remote team input component and a cell-local team input component;
means for aggregating information received by said collection component, said information being aggregated according to identifiable geographical areas of interest;
a searchable data storage component for storing said aggregated information; and
a broker component for receiving a data request, searching said data storage component based on said request, and exchanging information retrieved from said data storage component for value.

13. The engine of claim 12 including an access component providing secure access to said transaction component.

14. The system of claim 12 wherein said areas of interest are non-political.

15. The system of claim 12 wherein said areas of interest are political.

16. A computer-based system for managing the collection, storage, aggregation and dissemination of spatial data, comprising:
means for defining a cell-remote team and a cell-local team;
means for communicating between said cell-remote team and said cell-local team;
means for defining a geographic area of interest (AOI);
means for associating a group of cells with said AOI;
means for gathering information pertaining to at least one of said cells;
means for determining whether a cell has complete information or has incomplete information, and if incomplete, whether said cell is partially complete or has not been visited by a field team member;
means for locating at least one field agent of said cell-local team;
means for notifying at least one field agent of said cell-local team based on said field agent's location; and
means for notifying at least one field agent based on a signal to a location associated with a cell.

17. The system of claim 16 further including means for monitoring cell and cell feature status.

18. The system of claim 16 further including means for determining the quality of information received from said cell-local team.

19. The system of claim 16 further including means for verifying and validating information received from said cell-local team.

20. The system of claim 16 further including means for brokering requests for information pertaining to said AOI.

21. The system of claim 16 further including means for rewarding a field agent based on collected information.

22. A distributed spatial knowledge engine, comprising:
means for defining a geographic area of interest (AOI) having a plurality of cells associated therewith;
means for providing two-way communicating between a cell-remote team and a cell-local team;
means for establishing a baseline knowledge set associated with said AOI;
detecting means associated with said cell-local team for detecting a potential change to said baseline knowledge set; and
determining means associated with said cell-remote team for determining whether said detected potential change is to be reflected in an updated baseline knowledge set.

23. The engine of claim 22 wherein said cell-local team comprises at least one registered user.

24. The engine of claim 22 wherein said cell-local team comprises at least one unregistered user, and wherein said means for providing two-way communication includes means for registering said unregistered user.

25. The engine of claim 22 wherein said determining means includes means for determining a score associated with said detected potential change.

26. The engine of claim 22 wherein said determining means includes means for evaluating said cell-local team.

27. The engine of claim 22 wherein said determining means includes means for dispatching a second cell-local team comprising at least one validated user to said AOI.

28. The engine of claim 22 wherein said detecting means includes receiving input from a plurality of members of said cell-local team, and wherein said engine further includes means for measuring and recording the effectiveness of the input from said plurality of members.

29. A method of displaying a common operational picture on a viewing device, comprising the steps of:
providing a display device showing a display associated with a geographical area of interest (AOI);
providing input for use by said display as a baseline configuration;
receiving update input from a cell-local communicator associated with at least one attribute of an object within said AOI;
evaluating said update input for a reliability level; and
upon said update input being determined as reliable, updating said display on said display device to reveal said update input and redefining said baseline configuration to include said update input.
